(19) United States
(12) Patent Application Publication
(10) Pub. No.: US 2009/0224944 A1
(43) Pub. Date: Sep. 10, 2009

(54) Vehicle collision avoidance and warning system

(76) Inventor: Tien-Bou Wan, Tainan City (TW)

Correspondence Address: Tien-Bou, Wan, No.2, Alley 492, Hai Tien, Sec.2, Tainan, 709, TW

(21) Appl. No.: 12/074,338

(22) Filed: Mar. 4, 2008

(51) Int. Cl. G08G 1/01

(52) U.S. Cl. 340/936

(57) ABSTRACT

The present invention relates to an automatic vehicle collision avoidance and warning system for rear vehicles which comprises a radar sensor device, speed sensor device, main control module and an assistive brake light illumination, wherein the radar sensor device is located at the rear-end of the vehicle for detecting the safety distance there between; the speed sensor device is adapted for detecting the driving speed of the rear vehicles; the main control module is used to receive and read the data from the radar sensor device and speed sensor device; and the assistive brake light illumination is located at the rear end of the vehicle so as to be activated when the rear vehicle is impending.

### BACKGROUND OF THE PRESENT INVENTION

1. Field of the Invention

The present invention relates to a vehicle warning system, more particularly to a collision avoidance warning system to prevent from the impending vehicles from rear-end.

2. Description of Related Invention

Referring to a conventional vehicle warning system, a radar sensor device is located at the front-end of the vehicle for detecting the distance of the vehicle in the front there between, and activates the warning system when the distance there between is closer than the safety distance. However, the warning system for the rear vehicles is in passive pattern, which means the system is unable to avoid the collision from the impending vehicle from the rear end unless that equips with a distance warning system itself.

### SUMMARY OF THE PRESENT INVENTION

The present invention relates to an automatic vehicle collision avoidance and warning system for rear vehicles which comprises a radar sensor device, a speed sensor device, a central control module and an assistive brake light illumination. The radar sensor device is located at rear-end of the vehicle to measure the distance between two moving vehicles. The central control module of the present invention is configured to illuminate the assistive brake light illumination so as to invoke the warning signal to the impending vehicle which is causing the threat to the host vehicle. The central control module is able to automatically assess the driving speed of the incoming vehicle from the rear end so as to invoke the warning signal illuminated from the assistive brake light illumination when that being in excess of safety distance it should keep.

### BRIEF DESCRIPTION OF THE DRAWINGS

FIG. 1 is a system flow diagram of the preferred embodiment of the present invention.

### DETAILED DESCRIPTION OF THE PREFERRED EMBODIMENT

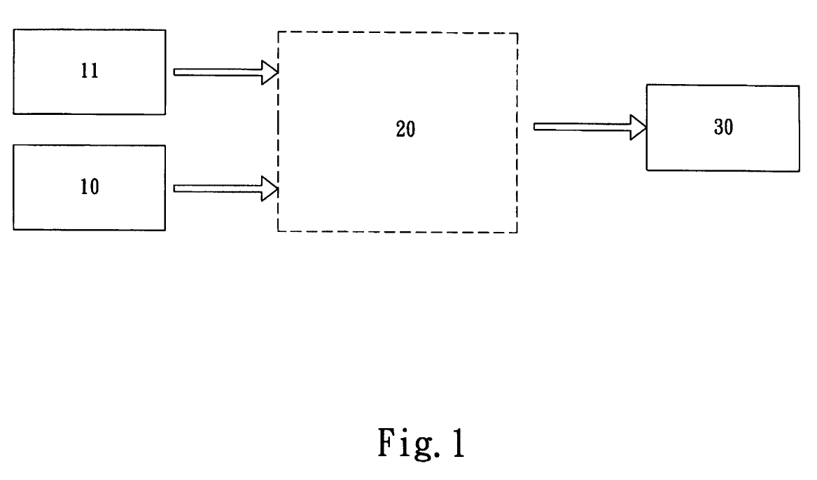

Referring to FIG. 1 of the Flow Diagram of the Present Invention Detailed Description of the Preferred Embodiment

Referring to FIG. 1 of the drawings, the automatic vehicle collision avoidance and warning system for rear-end vehicles according to the preferred embodiment of the present invention comprises a radar sensor device (10), a speed sensor device (11), a central control module (20) and an assistive brake light illumination (30). The radar sensor device (10) is located at rear-end of the vehicle for measuring the distance between the host vehicle and the rear vehicle. The speed sensor device (11) is adapted for detecting the driving speed of the vehicle form the rear end. The central control module (20) is equipped inside the vehicle so as to analyze the data received from the radar sensor device (10). The assistive brake light illumination (30) is positioned at rear-end of the vehicle for being activated to warn the vehicles from the rear end when that sensors the distance there between being too close to causing threat.

When the vehicle from the rear end is coming toward, the radar sensor device (10) is activated to measure the safety distance it needs between two moving vehicles. The central control module (20) is configured to assess the readings of driving speed of the rear vehicle which is detected from the speed sensor device (11) so as to illuminate the assistive brake light illumination (30) to invoke the warning signal to the impending vehicles from the rear end.

What is claimed is:

1. A vehicle collision avoidance and warning system for rear vehicle, comprising: a radar sensor device, wherein said radar sensor device is located at the rear-end of the vehicle so as to measure the distance and the speed of the incoming vehicle from the rear end; a speed sensor device for detecting the driving speed of the incoming vehicle; a central control module, wherein said central control module is located inside the vehicle for assessing the reading received from said radar sensor device; and an assistive brake light illumination, wherein said assistive brake light illumination is located at the rear-end of the vehicle for being invoked to warn the impending vehicle from the rear end which is causing the threat.

2. The system of claim 1, wherein said central control module is able to automatically analyze the readings of the distance and the speed of the rear vehicle which are received from said radar sensor device and said speed sensor device so as to invoke and illuminate said assistive brake light illumination for warning the incoming vehicle from the rear end.
